(19) United States
(12) Patent Application Publication
(10) Pub. No.: US 2018/0137739 A1
(43) Pub. Date: May 17, 2018

(54) ITEM LOCATOR

(71) Applicant: Ralph K. Dyer, Boynton Beach, FL (US)

(72) Inventor: Ralph K. Dyer, Boynton Beach, FL (US)

(21) Appl. No.: 15/349,614

(22) Filed: Nov. 11, 2016

(51) Int. Cl. G08B 21/24

(52) U.S. Cl. CPC G08B 21/24

(57) ABSTRACT

An item locator system, comprising a receiver module, having electrical components therein to determine if a stolen item has moved a predetermined distance from the receiver module; and a tracking device, for mounting to an item to be tracked, having mounted therein electrical components to communicate to the receiver module a position that the tracking device is at.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

### (1) Field of Invention

The present invention relates to lost item locators and, more particularly, to a new selectable lost item locator system for finding particular items either misplaced or lost.

### (2) Background of Invention

In the related art, it has long been known to use various kinds of apparatus or systems that afford a unique method of identifying the location of a plurality of missing or lost items. Objects that are easily lost include television remote controls, portable telephones, check books, purses, etc. Searching for lost or misplaced objects is often a very time-consuming task.

The use of lost item locators is known in the prior art. More specifically, the lost item locators heretofore devised and utilized are known to consist basically of familiar, expected and obvious structural configurations, notwithstanding the myriad of designs encompassed by the crowded prior art which have been developed for the fulfillment of countless objectives and requirements. Wherein the following patents are herein incorporated by reference for their supportive teachings, and include the following:

U.S. Pat. No. 5,939,981, issued to Renney, is a device which functions to locate pre-selected items which are remote from a user. The device comprises two parts; a hand held device and multiple sensors/chips which are applied to objects the user desires to locate. The hand held devices contains a control panel selector buttons for each multiple sensors/chip it is desired to locate. When a pre-selected button is depressed, a transmitter sends signal containing pre-selected code. The signal is received by a receiver in each multiple sensors /chip. The receiver in each multiple sensors/chip reads the code and if a match is obtained the receiver enables an audio tone generator in the multiple sensors/chip to send a tone through an audio speaker.

U.S. Pat. No. 7,301,453, issued to Terry L. Fry, discloses the method for locating a person or article preferably uses an audible feedback signal to the user for informing the user, when moving, whether the relative position of the beacon tag is getting closer to the finder or farther from the finder. The locator system includes at least one beacon tag comprising a transmitter programmed to transmit a unique coded pulse signal.

U.S. Pat. No. 7,420,465 issued to Rudolf Ritter concerns to a method for finding lost or stolen objects, including products, intellectual property, persons and animals, on the basis of RFID (Radio Frequency Identification) tags. This pertains to reading a RFID tag affixed to the object and through pairing of identification in the tag with identification in the owner's SIM card. If the tag is read with an RFID reader device in the mobile device or connected with the mobile device, this pairing can be performed automatically by the RFID reader device.

U.S. Pat. No. 8,847,754 issued to James Buchheim, teaches of device for providing a wireless communications component, configured to send and receive wireless signals such that the device is locatable via a wireless means; the wireless communications component including: a received signal strength indicator module for measuring signal strength of a wireless signal received at a the wireless communicatins component, wherein the device is configured to be tracked by a mobile computing device running a mobile application wherein the distance of the device from the mobile computing device is calculating by the mobile application upon receiving between one and three received signal strength indicator values.

While these devices fulfill their respective, particular objectives and requirements, the aforementioned patents do not disclose a new selectable lost item locator system. What is needed is a system or method that solves one or more of the problems described herein and/or one or more problems that may come to the attention of one skilled in the art upon becoming familiar with this specification.

### BRIEF SUMMARY OF THE INVENTION

In view of the foregoing disadvantages inherent in the known types of item locator devices and systems now present in the prior art, the present invention provides a new selectable lost item locator system wherein the has been developed to provide a security system for tracking lost or stolen items and use on process of various components employed in the procedure. As such, the general purpose of the present invention, which will be described subsequently in greater detail, is to provide a new and improved selectable lost item locator system which has all the advantages of the prior art and none of the disadvantages.

Accordingly, it is a primary aspect of the present invention to provide a new selectable lost item locator system to track the lost or stolen items. For the purpose, chips are provided which are applied to objects the user desires to locate.

In another aspect, the present invention provides a hand held device which functions to locate the preselected items which are remote from the user.

It is yet another aspect of the present invention where the handheld device can either a smartphone app or a component that picks up signals like a remote or a key fob.

In still another aspect, the present invention provides a new selectable lost item locator system where the tracking module may be a global positioning system.

In still another aspect, the present invention provides a new selectable lost item locator system where the receiver or locator unit would retrieve the item as the user get close to it either by beeping or flashing the light.

Further aspect of the present invention provides an economical, reliable, robust and easy to use lost item locator system for tracking the lost or stolen items.

It is still another aspect of the present invention to provide an item locator system, comprising a receiver module, having electrical components therein to determine if a stolen item has moved a predetermined distance from the receiver module; and a tracking device, for mounting to an item to be tracked, having mounted therein electrical components to communicate to the receiver module a position that the tracking device is at.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a perspective view of the retriever chips located on the various utility items.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

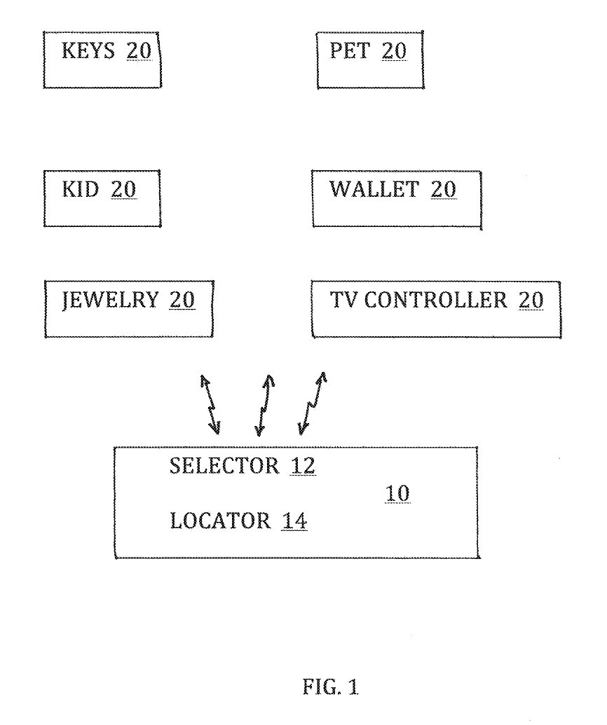

Referring to FIG. 1, there is an item locator system. Specifically, there is a receiver module 10, having electrical components therein to determine if a stolen item has moved a predetermined distance from the receiver module 10. There is also a tracking device 20, for mounting to an item to be tracked, having mounted therein electrical components to communicate to the receiver module 10 a position that the tracking device is at.

By way of operation, a user will activate the selector feature 12, which will allow a user to select which item they want to locate. Potential items may include, but not limited to: jewelry, TV controller, a kid, wallet, keys, or a pet. Once the user has selected a particular item, then the user will activate the locator feature 14. The locator feature 14 will activate the electronics in the receiver module 10 to communicate to the selected item and thereby activate the electronics in the tracking devices 20 that are mounted to the plurality of individual items.

In some preferred embodiments, the present invention provides a selectable lost item locator system which functions to locate the preselected items which are remote from a user. The present invention comprises two parts; a hand held device and chips which are applied to items the user desires to locate. The receiver or locator unit provided by the hand held device is either a smartphone app or a component that picks up signals like a remote or a key fob. The receiver or locator unit would retrieve the item as the user get close to it either by beeping or flashing the light. The chips act as the tracking unit, where the tracking module may be a global positioning system.

In further embodiment, the hand held devices contains a control panel selector buttons for each chip it is desired to locate. When a preselected button is depressed, a transmitter sends signal containing preselected code. The signal is received by a receiver in each chip. The receiver in each chip reads the code and if a match is obtained the receiver enables a beep or flashes the light in the chip to send the notification for the lost item, indicating the user thereof.

In one embodiment, the chip works by communicating with the app and GPS on the phone. The chip, thus, send a signal to the phone to beep when close to lost item. In one embodiment, for longer distances, the GPS in the smartphone and chip is utilized to locate the lost or stolen items. In one embodiment, the present system utilizes the fob or remote to locate the lost or stolen item at shorter distances.

It is yet another aspect of the invention to provide a a new and improved selectable lost itme retrieer locator system which is of a jewellery item. Moveover, it is also contemplated to make the present invention waterproof by known waterproofing means. Additionally, the invention may also include a paanic button conneted to the microchip for a person to be able to signal for help. Further, it is noted that the invention may be designed to be actiated when the tag is moved a certain distance, like 10 feet or 200 feet, away from a monitoring device, or the cell phone.

In accordance with the invention, the selectable lost item locator system also comprises a plurality of receiver assemblies each including a housing member, and also including a receiver chip being conventionally disposed in the housing member, and further including a beep-producing member and/or light-flashing member being conventionally attached to the housing member and being conventionally connected to the receiver chip. Each of the receiver assemblies further includes a microprocessor being conventionally disposed in the housing member, and also includes a power source for energizing the microprocessor and the receiver chips. Each receiver includes a unique radio frequency chip for responding to a unique frequency radio wave being transmitted by the variable radio transmitter.

As may now be appreciated from the above description and reference to the accompanying drawings, the present invention provides a selectable lost item locator system which may be utilized by the user to locate the lost or stolen predetermine item.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An item locator system, comprising:
a) a receiver module, having electrical components therein to determine if a stolen item has moved a predetermined distance from the receiver module; and
b) a tracking device, for mounting to an item to be tracked, having mounted therein electrical components to communicate to the receiver module a position that the tracking device is at.

2. The item locator system as claimed in claim 1, wherein the the system is utilized to locate the item.

3. The item locator system as claimed in claim 1, wherein the the receiver is a smartphone.

4. The item locator system as claimed in claim 1, wherein the the receiver is a component that picks up signals like a remote control or a key fob.

5. The item locator system as claimed in claim 1, wherein the receiver retrieves the item as the user get close to it either by beeping and flashing a light.

6. The item locator system as claimed in claim 1, wherein the the chips act as the tracking unit.

7. The item locator system as claimed in claim 1, wherein the tracking module is a global positioning system (GPS) to locate the items at longer distances.

8. The item locator system as claimed in claim 1, wherein the tracking module is a fob to locate the items at shorter distances.
